(19) United States
(12) Patent Application Publication
(10) Pub. No.: US 2012/0290819 A1
(43) Pub. Date: Nov. 15, 2012

(54) DSP BLOCK WITH EMBEDDED FLOATING POINT STRUCTURES

(75) Inventor: Martin Langhammer, Alderbury (GB)

(73) Assignee: ALTERA CORPORATION, San Jose, CA (US)

(21) Appl. No.: 13/187,801

(22) Filed: Jul. 21, 2011

Related U.S. Application Data
(60) Provisional application No. 61/483,924, filed on May 9, 2011.

(51) Int. Cl. G06F 9/302

(52) U.S. Cl. 712/222; 712/E09.017

(57) ABSTRACT

A specialized processing block includes a first floating-point arithmetic operator stage, a second floating-point arithmetic operator stage, and configurable interconnect within the specialized processing block for routing signals into and out of each of the first and second floating-point arithmetic operator stages. In some embodiments, the configurable interconnect may be configurable to route a plurality of block inputs to inputs of the first floating-point arithmetic operator stage, at least one of the block inputs to an input of the second floating-point arithmetic operator stage, output of the first floating-point arithmetic operator stage to an input of the second floating-point arithmetic operator stage, at least one of the block inputs to a direct-connect output to another such block, output of the first floating-point arithmetic operator stage to the direct-connect output, and a direct-connect input from another such block to an input of the second floating-point arithmetic operator stage.

### CROSS REFERENCE TO RELATED APPLICATION

This claims the benefit of, and priority to, copending, commonly-assigned U.S. Provisional Patent Application No. 61/483,924, filed May 9, 2011, which is hereby incorporated by reference herein in its entirety.

### FIELD OF THE INVENTION

This invention relates to a programmable integrated circuit device, and particularly to a specialized processing block in a programmable integrated circuit device.

### BACKGROUND OF THE INVENTION

Considering a programmable logic device (PLD) as one example of an integrated circuit device, as applications for which PLDs are used increase in complexity, it has become more common to design PLDs to include specialized processing blocks in addition to blocks of generic programmable logic resources. Such specialized processing blocks may include a concentration of circuitry on a PLD that has been partly or fully hardwired to perform one or more specific tasks, such as a logical or a mathematical operation. A specialized processing block may also contain one or more specialized structures, such as an array of configurable memory elements. Examples of structures that are commonly implemented in such specialized processing blocks include: multipliers, arithmetic logic units (ALUs), barrel-shifters, various memory elements (such as FIFO/LIFO/SIPO/RAM/ROM/CAM blocks and register files), AND/NAND/OR/NOR arrays, etc., or combinations thereof.

One particularly useful type of specialized processing block that has been provided on PLDs is a digital signal processing (DSP) block, which may be used to process, e.g., audio signals. Such blocks are frequently also referred to as multiply-accumulate (“MAC”) blocks, because they include structures to perform multiplication operations, and sums and/or accumulations of multiplication operations.

For example, PLDs sold by Altera Corporation, of San Jose, Calif., as part of the STRATIX® and ARRIA® families include DSP blocks, each of which includes a plurality of multipliers. Each of those DSP blocks also includes adders and registers, as well as programmable connectors (e.g., multiplexers) that allow the various components of the block to be configured in different ways.

Typically, the arithmetic operators (adders and multipliers) in such specialized processing blocks have been fixed-point operators. If floating-point operators were needed, the user would construct them outside the specialized processing block using general-purpose programmable logic of the device, or using a combination of the fixed-point operators inside the specialized processing block with additional logic in the general-purpose programmable logic.

### SUMMARY OF THE INVENTION

In accordance with embodiments of the present invention, specialized processing blocks such as the DSP blocks described above may be enhanced by including floating-point addition among the functions available in the DSP block. This reduces the need to construct floating-point functions outside the specialized processing block. The addition function may be a wholly or partially dedicated (i.e., “hard logic”) implementation of addition in accordance with the IEEE754-1985 standard, and can be used for addition operations, multiply-add (MADD) operations, or vector (dot product) operations, any of which can be either real or complex. The floating-point adder circuit may be incorporated into the DSP Block, and can be independently accessed, or used in combination with a multiplier in the DSP block, or even multipliers in adjacent DSP blocks.

Therefore, in accordance with embodiments of the present invention there is provided a specialized processing block on a programmable integrated circuit device. The specialized processing block includes a first floating-point arithmetic operator stage, a second floating-point arithmetic operator stage, and configurable interconnect within the specialized processing block for routing signals into and out of each of the first and second floating-point arithmetic operator stages. There is also provided a programmable integrated circuit device comprising a plurality of such specialized processing blocks.

In some embodiments, the specialized processing block includes a plurality of block inputs, at least one block output, a direct-connect input from another one of the specialized processing blocks, and a direct-connect output to another one of the specialized processing blocks. In some of those embodiments, the configurable interconnect may be configurable to route a plurality of the block inputs to inputs of the first floating-point arithmetic operator stage, at least one of the block inputs to an input of the second floating-point arithmetic operator stage, output of the first floating-point arithmetic operator stage to an input of the second floating-point arithmetic operator stage, at least one of the block inputs to the direct-connect output, output of the first floating-point arithmetic operator stage to the direct-connect output, and the direct-connect input to an input of the second floating-point arithmetic operator stage.

### BRIEF DESCRIPTION OF THE DRAWINGS

Further features of the invention, its nature and various advantages will be apparent upon consideration of the following detailed description, taken in conjunction with the accompanying drawings, in which like reference characters refer to like parts throughout, and in which:

FIG. 1 shows a logical diagram of an exemplary specialized processing block incorporating an embodiment of the present invention;

FIG. 1A shows a logical diagram of an exemplary specialized processing block incorporating an embodiment of the present invention;

FIG. 2 shows a more detailed diagram of an exemplary specialized processing block according to an embodiment of the present invention;

FIG. 3 shows a simplified block diagram of number of exemplary specialized processing blocks according to an embodiment of the present invention, in an exemplary arrangement according to an embodiment of the present invention;

FIG. 4 shows an exemplary arrangement of exemplary specialized processing blocks according to an embodiment of the invention configured to perform a dot product;

FIG. 5 shows an exemplary arrangement of exemplary specialized processing blocks similar to FIG. 4 with rounding implemented outside the blocks;

FIG. 6 shows an exemplary selection of datapaths when the exemplary arrangement of FIG. 4 is used to implement a vector dot product operation;

FIG. 7 shows an exemplary dedicated floating point adder block according to an embodiment of the present invention;

FIG. 8 shows an exemplary arrangement according to an embodiment of the invention, of a plurality of exemplary dedicated floating point adder blocks of FIG. 7;

FIG. 9 shows an exemplary use of the arrangement of FIG. 8 as a ternary adder tree; and

FIG. 10 is a simplified block diagram of an exemplary system employing a programmable logic device incorporating the present invention.

### DETAILED DESCRIPTION OF THE INVENTION

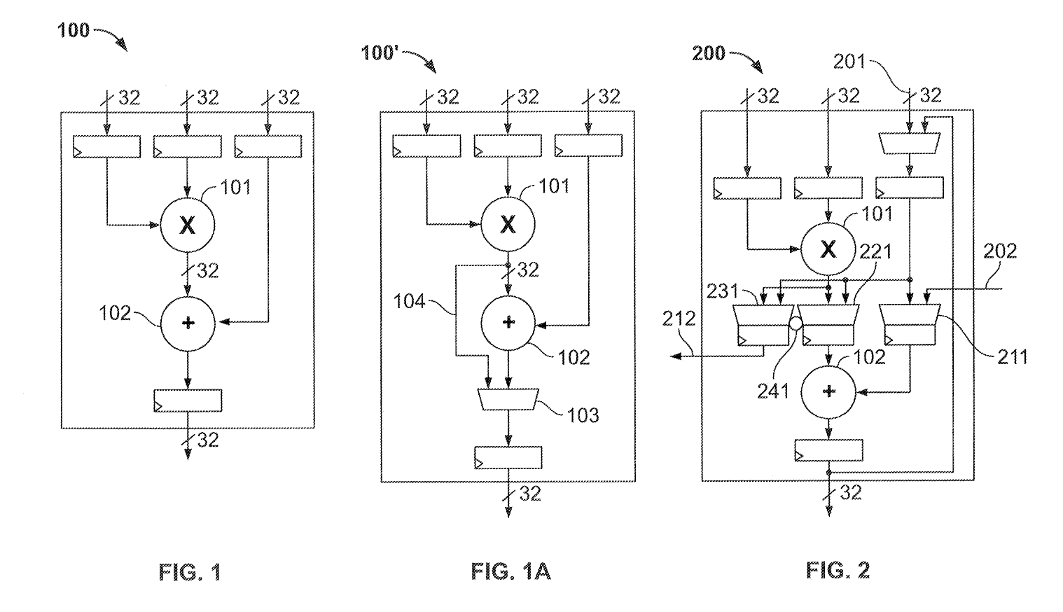

FIG. 1 shows a logical diagram of an exemplary DSP block 100 according to an embodiment of the invention. In this logical representation, implementational details, such as registers and some programmable routing features—such as multiplexers that may allow the output of a particular structure to be routed directly out of block 100—are omitted to simplify discussion. In addition, some elements that are shown may, in an actual embodiment, be implemented more than once. For example, the multiplier 101 may actually represent two or more multipliers, as in the DSP blocks of the aforementioned STRATIX® and ARRIA® families of PLDs.

In the logical representation of FIG. 1, the floating-point adder 102 follows a floating-point multiplier 101. The floating-point multiplier may be constructed from a 27×27 fixed-point multiplier supported by the DSP block provided in STRATIX® V or ARRIA® V programmable devices from Altera Corporation, and some additional logic. The additional logic calculates exponents, as well as special and error conditions such as NAN (not-a-number), Zero and Infinity. Optionally, other logic may be provided to round the result of the multiplier to IEEE754 format. Such rounding can be implemented as part of the final adder within the multiplier structure (not shown), or in programmable logic outside the DSP block 100 when the output of the multiplier 101 is outputted directly from the DSP block 100.

The floating point multiplier 101 can feed the floating point adder 102 directly in a multiplier-add (MADD) mode, as depicted in FIG. 1. Alternatively, as depicted in FIG. 1A, the multiplier 101 output can be routed around the adder 102 directly to the output of the DSP block, with a multiplexer 103 provided to select between the output of the multiplier 101 or the output of the adder 102. Although the bypass 104 and multiplexer 103 are omitted from the other drawings to avoid cluttering those drawings, they should be considered to be present in all of the multiplier/adder DSP blocks shown, including that of FIG. 1.

FIG. 2 shows a more detailed diagram of an exemplary DSP block 200 according to an embodiment of this invention. Optionally bypassable pipelining (not shown) may be provided between the floating-point multiplier 101 and the floating-point adder 102. Optionally bypassable pipelining (not shown) can also be provided within either or both of the floating-point multiplier 101 and the floating-point adder 102. Inputs can be routed to the adder 102 from multiple sources, including an output of the multiplier 101, one of the inputs 201 to the DSP block 200, or a direct connection 202 from an adjacent similar DSP block 200.

In addition, the output of multiplier 101 and/or one of the inputs 201 to the DSP block 200, can also be routed via a direct connection 212 to the adder in an adjacent similar DSP block 200 (it being apparent that, except at the ends of a chain of blocks 200, each direct connection 202 receives its input from a direct connection 212, and that each direct connection 212 provides its output to a direct connection 202). Specifically, multiplexer 211 may be provided to select either input 201 or direct connection 202 as one input to adder 102. Similarly, multiplexer 221 may be provided to select either input 201 or the output of multiplier 101 as another input to adder 102. A third multiplexer 231 may be provided to select either input 201 or the output of multiplier 101 as the output to direct connection 212. Thus the inputs to adder 102 can be either input 201 and the output of multiplier 101, or input 201 and direct connection 202, and direct connection 212 can output either input 201 or the output of multiplier 101.

In one embodiment, multiplexer 221 and multiplexer 231, which have the same two inputs (input 201 and the output of multiplier 101), share a control signal, but in the opposite sense as indicated at 241, so that if one of the two multiplexers selects one of those two inputs, the other of the two multiplexers selects the other of those two inputs.

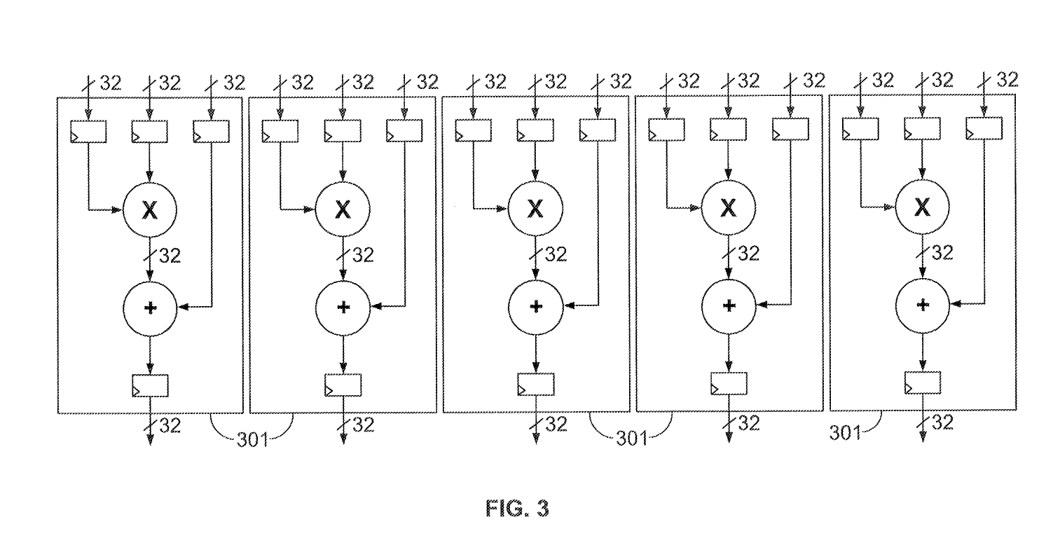

Multiple DSP blocks according to embodiments of the invention may be arranged in a row or column, so that information can be fed from one block to the next using the aforementioned direct connections 202/212, to create more complex structures. FIG. 3 shows a number of exemplary DSP blocks 301 according to an embodiment of the invention, arranged in a row 300 (without showing connections 202/212).

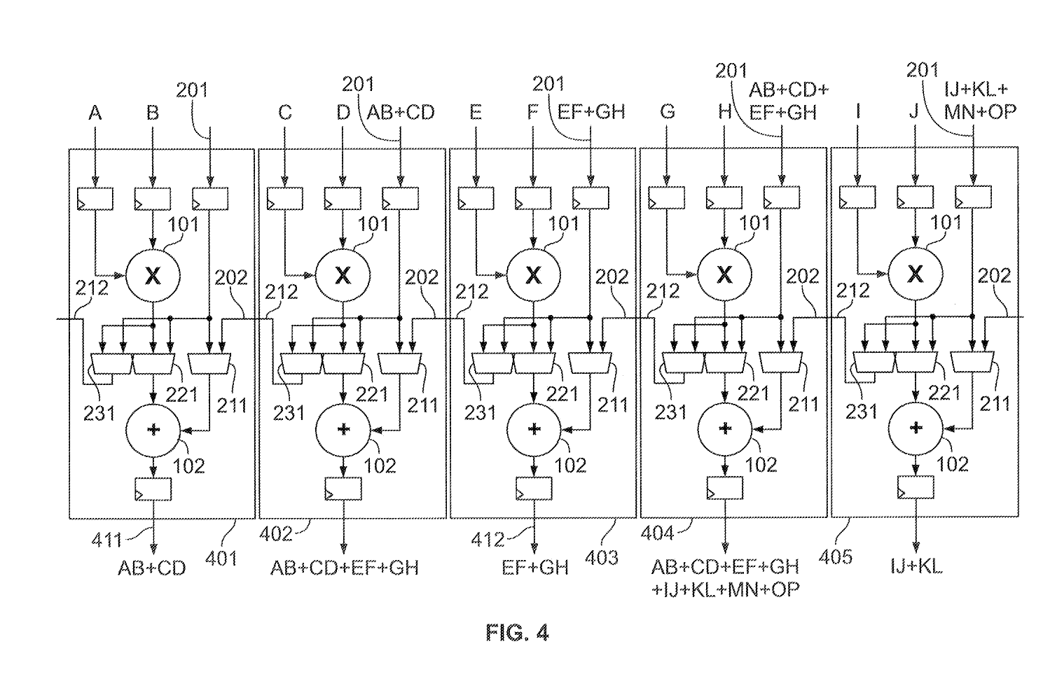

FIG. 4 shows a row 400 of five exemplary DSP blocks 401-405 according to an embodiment of the invention configured to perform a dot product operation. Alternatively, the DSP blocks 401 in that configuration could be arranged in a column (not shown) without changing the inputs and outputs. The drawing shows the interface signals. In each pair of blocks 401/402 and 403/404, the multiplier 101 in each block, along with the adder 102 in the leftmost block 401, 403 of the two blocks, implement a respective sum 411, 412 of two multiplication operations. Those sums 411, 412 are summed with the rightmost adder of the leftmost pair—i.e., adder 102 of DSP block 402—using multiplexer 211 to select input 202 and using multiplexer 221 to select input 201 (to which the respective output 411/412 has been routed, e.g., using programmable interconnect resources of the PLD outside the blocks 401-404)—to provide a sum of four multiplies. The rightmost adder of the rightmost pair—i.e., adder 102 of DSP block 404 is used to add this sum of four multiplies to the sum of four multiplies from another set of four DSP blocks beginning with DSP block 405 (remainder not shown). For N multipliers there will be N adders, which is sufficient to implement the adder tree of a dot product, which, for a pair of vectors of length N, is the sum of N multiplication operations.

The same DSP block features can be used to implement a complex dot product. Each second pair of DSP blocks would use a subtraction rather than an addition in the first level addition, which can be supported by the floating-point adder (e.g., by negating one of the inputs, in a straightforward manner). The rest of the adder tree is a straightforward sum construction, similar to that described in the preceding paragraph.

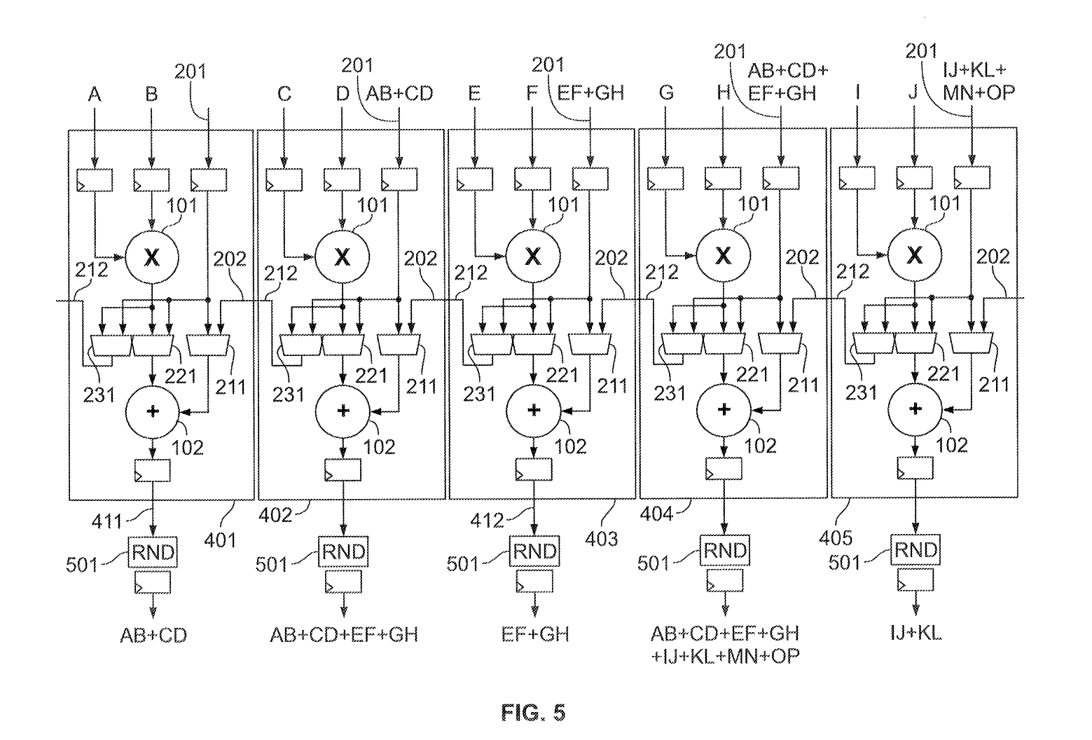

As discussed above, IEEE754-compliant rounding can be provided inside embodiments of the DSP block, or can be implemented in the general-purpose programmable logic portion of the device. FIG. 5 shows as an example the arrangement of FIG. 4 with rounding implemented at 501 outside the block—i.e., in the general-purpose programmable logic portion of the device. The rounding can be implemented with a single level of logic, which may be as simple as a carry-propagate adder, followed by a register. Assuming, as is frequently the case, that all of the outputs of the DSP blocks must be rounded, there would be no disturbance or rebalancing of the datapath required.

Another feature that could be implemented in dedicated logic is the calculation of an overflow condition of the rounded value, which can be determined using substantially fewer resources than the addition. Additional features could calculate the value of a final exponent, or special or error conditions based on the overflow condition.

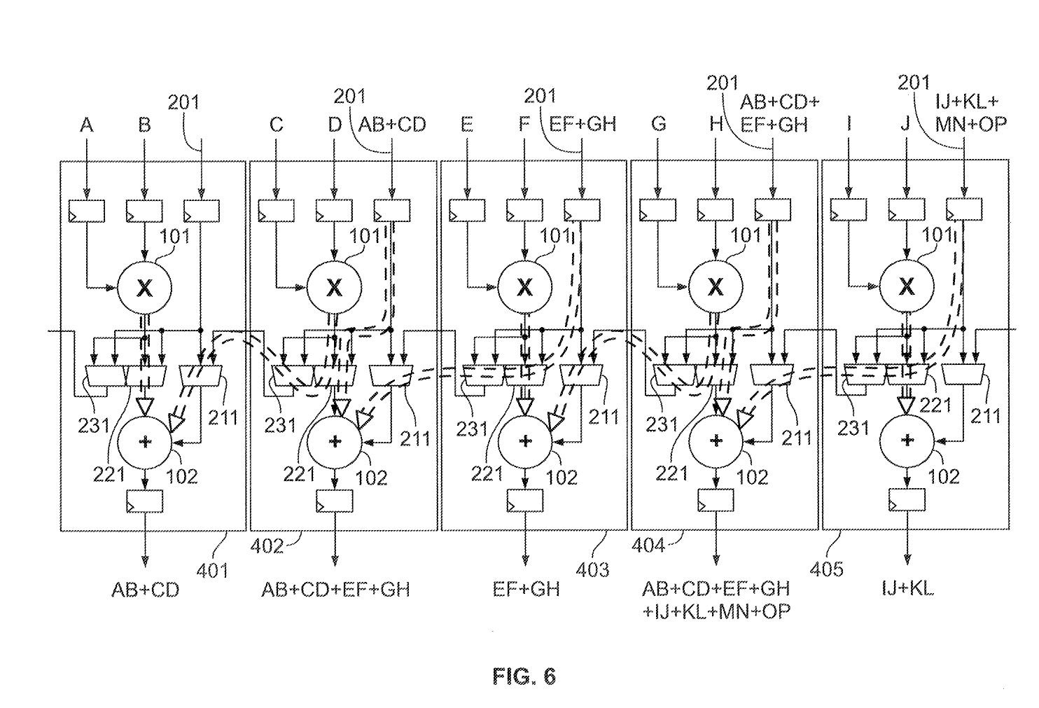

For the illustrated method of adder tree implementation, each DSP block output other than the output of the last block is fed back to the input of another DSP block. In some cases the output is fed back to an input of the same block, such as the EF+GH output 412 in FIG. 4. As seen in FIG. 2, an internal bus 250 may be provided to feed the output register of a block back to an input register, saving routing resources in the general-purpose programmable logic portion of the device. FIG. 6 shows in phantom an exemplary selection of datapaths by multiplexers 211, 221, 231 for the dot product application example described earlier in connection with FIG. 4, showing how adder 102 of each block 401-405 adds a product of the multiplier 101 in that block and a product from an adjacent block.

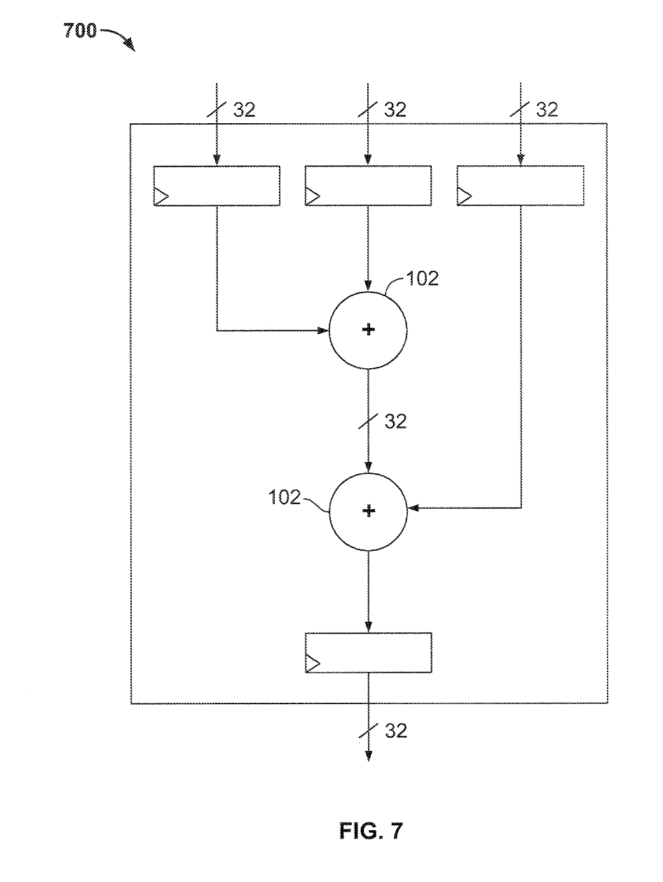

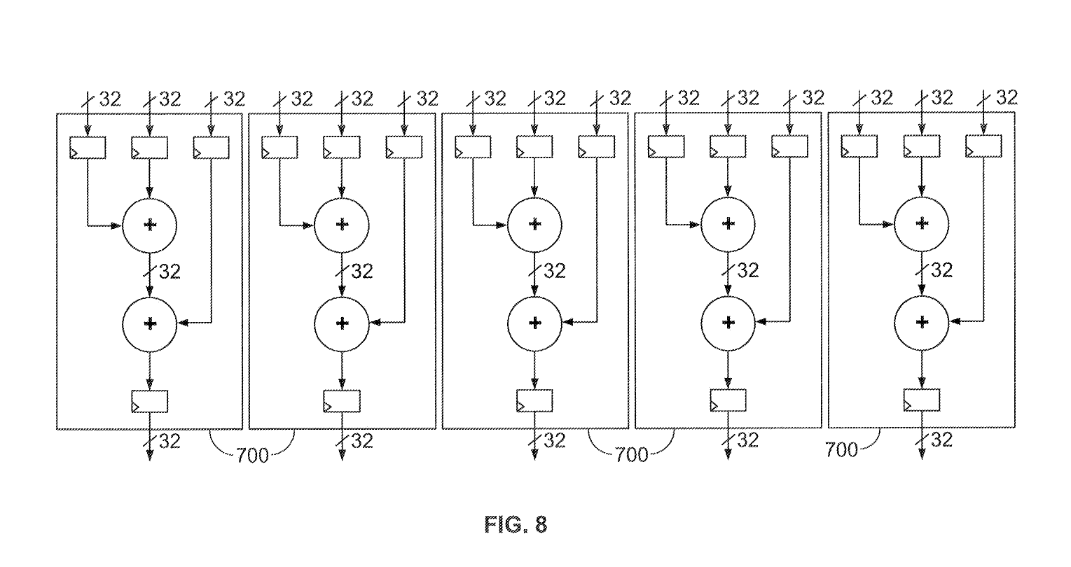

Another embodiment of a dedicated floating-point processing block is a dedicated floating-point adder block. Such a block can be binary (2 input operands) or ternary (3 input operands). FIG. 7 shows a logical block diagram of an exemplary ternary adder block 700. As with the previously described DSP block, pipelining may or may not be used internally, and rounding may be supported either internally or externally in programmable logic. Also as with the DSP block, the adder blocks can be arranged in rows, as shown in the example in FIG. 8, or columns. Alternatively, adder blocks can be interleaved (not shown) with the multiplier-adder DSP blocks described above.

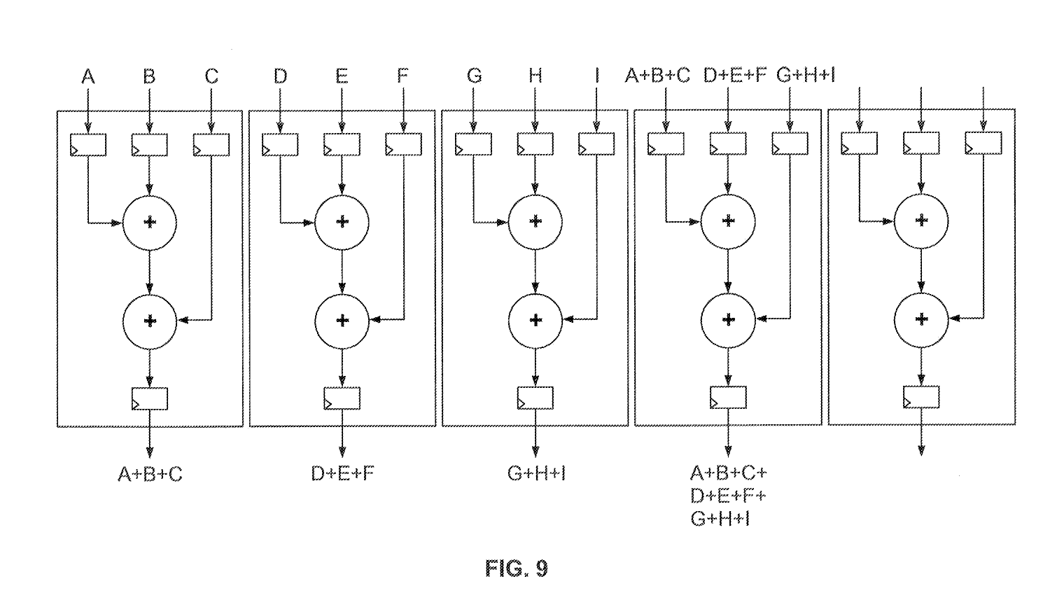

FIG. 9 shows, using labels, exemplary connections used with blocks 700 arranged as in FIG. 8 to make a ternary floating-point adder tree. The ternary adder tree has a depth of log₃ N, which is half that of a binary adder. In this example, N=9, and four blocks are arranged in two levels (depth=log₃(9)=2). As discussed above in connection with FIGS. 4 and 5, rounding can be provided either inside or outside the blocks (not shown).

By providing specialized processing blocks, including dedicated but configurable floating point operators, the present invention allows the implementation of certain operations, such as the vector dot product described above, with less reliance on programmable logic outside the blocks.

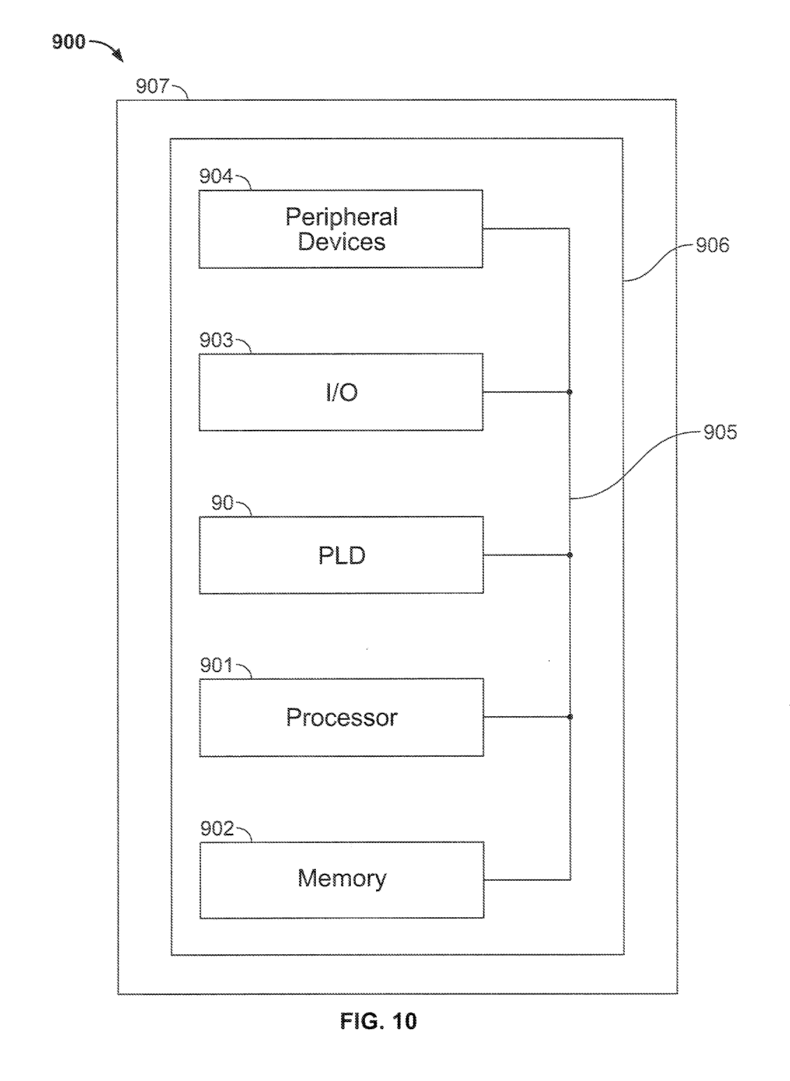

A PLD 90 incorporating specialized processing blocks according to the present invention may be used in many kinds of electronic devices. One possible use is in an exemplary data processing system 900 shown in FIG. 10. Data processing system 900 may include one or more of the following components: a processor 901; memory 902; I/O circuitry 903; and peripheral devices 904. These components are coupled together by a system bus 905 and are populated on a circuit board 906 which is contained in an end-user system 907.

System 900 can be used in a wide variety of applications, such as computer networking, data networking, instrumentation, video processing, digital signal processing, or any other application where the advantage of using programmable or reprogrammable logic is desirable. PLD 90 can be used to perform a variety of different logic functions. For example, PLD 90 can be configured as a processor or controller that works in cooperation with processor 901. PLD 90 may also be used as an arbiter for arbitrating access to a shared resources in system 900. In yet another example, PLD 90 can be configured as an interface between processor 901 and one of the other components in system 900. It should be noted that system 900 is only exemplary, and that the true scope and spirit of the invention should be indicated by the following claims.

Various technologies can be used to implement PLDs 90 as described above and incorporating this invention.

It will be understood that the foregoing is only illustrative of the principles of the invention, and that various modifications can be made by those skilled in the art without departing from the scope and spirit of the invention. For example, the various elements of this invention can be provided on a PLD in any desired number and/or arrangement. One skilled in the art will appreciate that the present invention can be practiced by other than the described embodiments, which are presented for purposes of illustration and not of limitation, and the present invention is limited only by the claims that follow.

What is claimed is:

1. A specialized processing block on a programmable integrated circuit device, said specialized processing block comprising:
a first floating-point arithmetic operator stage;
a second floating-point arithmetic operator stage; and
configurable interconnect within said specialized processing block for routing signals into and out of each of said first and second floating-point arithmetic operator stages.

2. The specialized processing block of claim 1 wherein:
said first floating-point arithmetic operator stage comprises a floating-point multiplier; and
said second floating-point arithmetic operator comprises a floating-point adder.

3. The specialized processing block of claim 1 wherein each of said first and second floating-point arithmetic operator stages comprises a floating-point adder.

4. The specialized processing block of claim 1 wherein:
said configurable interconnect comprises a selectable bypass of said second floating-point arithmetic operator stage; whereby:
output of said first floating-point arithmetic operator stage is routable out of said specialized processing block.

5. The specialized processing block of claim 1 further comprising:
a plurality of block inputs;
at least one block output;
a direct-connect input from another one of said specialized processing block; and
a direct-connect output to another one of said specialized processing block.

6. The specialized processing block of claim 5 wherein:
said configurable interconnect is configurable to route:
at least some of said block inputs to inputs of said first floating-point arithmetic operator stage,
at least one of said block inputs to an input of said second floating-point arithmetic operator stage,
output of said first floating-point arithmetic operator stage to an input of said second floating-point arithmetic operator stage,
at least one of said block inputs to said direct-connect output,
output of said first floating-point arithmetic operator stage to said direct-connect output, and
said direct-connect input to an input of said second floating-point arithmetic operator stage.

7. The specialized processing block of claim 6 wherein said configurable interconnect comprises:
a first multiplexer for selecting, as a first input to said second floating-point arithmetic operator stage, between one of said block inputs and said direct-connect input;
a second multiplexer for selecting, as a second input to said second floating-point arithmetic operator stage, between said one of said block inputs and an output of said first floating-point arithmetic operator stage; and
a third multiplexer for selecting, as said direct-connect output, between said one of said block inputs and said output of said first floating-point arithmetic operator stage.

8. The specialized processing block of claim 7 wherein said second multiplexer and said third multiplexer share opposite senses of a common control signal.

9. The specialized processing block of claim 6 wherein said configurable interconnect includes a feedback path for selectably routing output of said second floating-point arithmetic operator stage to one of said block inputs.

10. The specialized processing block of claim 5 wherein said configurable interconnect includes a feedback path for selectably routing output of said second floating-point arithmetic operator stage to one of said block inputs.

11. A programmable integrated circuit device comprising:
a plurality of specialized processing blocks, each of said specialized processing blocks comprising:
a first floating-point arithmetic operator stage;
a second floating-point arithmetic operator stage; and
configurable interconnect within said specialized processing block for routing signals into and out of each of said first and second floating-point arithmetic operator stages.

12. The programmable integrated circuit device of claim 11 wherein:
in each respective one of said specialized processing blocks, said first floating-point arithmetic operator stage comprises a floating-point multiplier; and
in each respective one of said specialized processing blocks, said second floating-point arithmetic operator comprises a floating-point adder.

13. The programmable integrated circuit device of claim 12 wherein at least one of said specialized processing blocks is configured for a multiply-add operation.

14. The programmable integrated circuit device of claim 11 wherein in each respective one of said specialized processing blocks, each of said first and second floating-point arithmetic operator stages comprises a floating-point adder.

15. The programmable integrated circuit device of claim 11 wherein:
in each respective one of said specialized processing blocks, said configurable interconnect comprises a selectable bypass of said second floating-point arithmetic operator stage; whereby:
output of each respective one of said first floating-point arithmetic operator stage is routable out of each of respective one of said specialized processing blocks.

16. The programmable integrated circuit device of claim 11 wherein:
each respective one of said specialized processing blocks further comprises:
a respective plurality of block inputs;
at least one respective block output;
a respective direct-connect input from another one of said specialized processing blocks; and
a respective direct-connect output to another one of said specialized processing blocks.

17. The programmable integrated circuit device of claim 16 wherein:
in each respective one of said specialized processing blocks, said configurable interconnect is configurable to route:
at least some of said block inputs to inputs of said first floating-point arithmetic operator stage,
at least one of said block inputs to an input of said second floating-point arithmetic operator stage,
output of said first floating-point arithmetic operator stage to an input of said second floating-point arithmetic operator stage,
at least one of said block inputs to said direct-connect output;
output of said first floating-point arithmetic operator stage to said direct-connect output, and
said direct-connect input to an input of said second floating-points arithmetic operator stage.

18. The programmable integrated circuit device of claim 17 wherein in each respective one of said specialized processing blocks, said configurable interconnect comprises:
a first multiplexer for selecting, as a first input to said second floating-point arithmetic operator stage, between one of said block inputs and said direct-connect input;
a second multiplexer for selecting, as a second input to said second floating-point arithmetic operator stage, between said one of said block inputs and an output of said first floating-point arithmetic operator stage; and
a third multiplexer for selecting, as said direct-connect output, between said one of said block inputs and said output of said first floating-point arithmetic operator stage.

19. The programmable integrated circuit device of claim 18 wherein in each respective one of said specialized processing blocks, said second multiplexer and said third multiplexer share opposite senses of a respective common control signal.

20. The programmable integrated circuit device of claim 19 wherein at least two of said specialized processing blocks are configured for a vector dot product operation using respective direct connect inputs and respective direct connect output of blocks in said plurality of specialized processing blocks.

21. The programmable integrated circuit device of claim 19 further comprising a programmable logic portion configured to round outputs of blocks in said plurality of specialized processing blocks.

22. The programmable integrated circuit device of claim 17 wherein in each respective one of said specialized processing blocks, said configurable interconnect includes a feedback path for selectably routing output of said second floating-point arithmetic operator stage to one said block inputs.

23. The programmable integrated circuit device of claim 16 wherein in each respective one of said specialized processing blocks, said configurable interconnect includes a feedback path for selectably routing output of said second floating-point arithmetic operator stage to one said block inputs.
